(19) United States
(12) Patent Application Publication
(10) Pub. No.: US 2008/0136994 A1
(43) Pub. Date: Jun. 12, 2008

(54) Backlight Unit And Liquid Crystal Display Device Having the Same

(75) Inventors: Kang Woo Lee, Seoul (KR); Joong Hyun Kim, Gyeonggi-Do (KR); Jin Sung Choi, Chungcheongnam-Do (KR); Jeong Hwan Lee, Gyeonggi-Do (KR); In Sun Hwang, Gyeonggi-Do (KR); Seock Hwan Kang, Gyeonggi-Do (KR)

Correspondence Address: CANTOR COLBURN, LLP, 20 Church Street, 22nd Floor, Hartford, CT, 06103, US

(73) Assignee: SAMSUNG ELECTRONICS CO., LTD., Gyeonggi-do (KR)

(21) Appl. No.: 11/932,549

(22) Filed: Oct. 31, 2007

(30) Foreign Application Priority Data
Dec. 12, 2006 (KR) 10-2006-0126426

(51) Int. Cl. F21V 21/00; G02F 1/13357

(52) U.S. Cl. 349/58; 362/374

(57) ABSTRACT

A backlight unit having a structure which supports a diffusion sheet without a diffusion plate and a liquid crystal display device having the same include a backlight unit, which includes a receiving member having a receiving space and a coupling hole formed therein, a fastening member coupled to the coupling hole of the receiving member, and a sheet having a fastening hole formed therein, wherein the fastening member is coupled to the fastening hole to fix the sheet to the receiving member.

This application claims priority to Korean Patent Application No. 10-2006-0126426, filed on Dec. 12, 2006, and all the benefits accruing therefrom under 35 U.S.C. § 119, the contents of which in its entirety are herein incorporated by reference.

### BACKGROUND OF THE INVENTION

1. Field of Invention

The present invention relates to a backlight unit and a liquid crystal display device having the same, and more particularly, to a backlight unit having a structure which fixes and supports a diffusion sheet without a diffusion plate and a liquid crystal display device having the same.

2. Description of the Related Art

Among flat panel displays, liquid crystal displays (“LCDs”) are used in many fields because of their lightweight, slim configuration, low power consumption, full color, high resolution and other desirable characteristics. For example, LCDs are currently used in computers, notebook computers, personal digital assistants (“PDAs”), telephones, televisions, audio/video equipment and other similar devices. An LCD device controls light transmissivity according to image signals applied to a plurality of control switches arranged in a matrix form to display a desired image on an LCD panel. Backlight units of the LCD device are classified as either a direct type backlight unit or an edge type backlight unit, depending upon a location of a light source. The direct type backlight unit has a light source disposed below the LCD panel, while the edge type backlight unit has a light source which is provided from a side of the LCD panel and uses a light guide plate.

Generally, in the direct type backlight unit, a diffusion plate is disposed over the light source and a plurality of optical sheets including a diffusion sheet and a prism sheet are disposed over the diffusion plate. The diffusion plate disperses light emitted from the light source to make the light uniform and functions as a support member for supporting the optical sheets. However, using the diffusion plate as the support member for the optical sheets deforms the diffusion plate, and there is also a problem in that scratches generated by friction between the diffusion plate and the LCD panel are visible on the LCD device. Hence, there is a need for an LCD device with a backlight unit which supports a diffusion sheet without a diffusion plate.

### BRIEF SUMMARY OF THE INVENTION

The present invention provides a backlight unit having a structure which supports a diffusion sheet without a diffusion plate and a liquid crystal display having the same.

According to an exemplary embodiment, a backlight unit includes a receiving member having a receiving space formed therein and a coupling hole formed therein; a fastening member coupled to the coupling hole of the receiving member; and a sheet having a fastening hole formed therein, wherein the fastening member is coupled to the fastening hole to fix the sheet to the receiving member.

The sheet may be a diffusion sheet including a base film, a plurality of diffusion beads distributed in the base film, and a diffusion pattern formed on the base film.

The receiving member may include a first mold frame, and the coupling hole may be formed in the first mold frame.

The receiving member may include a chassis, and the coupling hole may be formed in the chassis.

The receiving member may include a second mold frame coupled to a sidewall of the chassis, and the coupling hole may be formed in the second mold frame.

The fastening hole may be formed in a marginal region of the sheet.

The fastening member may include a first fastening member, the first fastening member including a first body and a first head formed at an end of the first body.

The first fastening member may further include a fixing section formed at an opposite end of the first body, the fixing section being larger than the coupling hole.

The first head may be formed to taper such that a thickness thereof is gradually reduced from one end to another end.

The first head may be formed to be inclined at a predetermined angle with respect to the first body.

A central axis of the first body of the first fastening member and a center of the fastening hole of the sheet may be eccentrically disposed with respect to each other.

The fastening hole of the sheet may be coupled to the first body of the first fastening member.

The fastening member may include a second fastening member, the second fastening member including a base section having an elastic structure, a protrusion section formed on the base section and coupled to the coupling hole of the receiving member, and a second body formed on the base section and coupled to the fastening hole of the sheet.

The base section may be formed in the shape of a close-looped curve, and a portion of the base section may be depressed toward a center of the base section and formed to be curved, thereby having an elastic structure.

The second fastening member may be formed by integrally connecting a plurality of the second fastening members.

A central axis of the second body of the second fastening member and a center of the fastening hole of the sheet may be eccentrically disposed with respect to each other.

The second fastening member may further include a second head formed at an end of the second body.

The coupling hole may be formed to correspond in size to the base section of the second fastening member.

The coupling hole may include a first coupling hole formed to correspond in size and location to the protrusion section of the second fastening member, and a second coupling hole formed to be larger than the second body of the second fastening member.

According to another exemplary embodiment of the present invention, a liquid crystal display device includes a receiving member having a receiving space formed therein and a coupling hole formed therein; a fastening member coupled to the coupling hole of the receiving member; a backlight unit including a diffusion sheet having a fastening hole formed therein, wherein the fastening member is coupled to the fastening hole to fix the diffusion sheet to the receiving member; and an LCD panel disposed over the backlight unit.

The LCD device may further include a light source unit disposed in the receiving member and an optical sheet disposed over the diffusion sheet.

### BRIEF DESCRIPTION OF THE DRAWINGS

The above and other aspects, features and advantages of the present invention will become apparent by describing in further detail exemplary embodiments thereof with reference to the accompanying drawings, in which:

FIG. 1 is an exploded top perspective view of a backlight unit according to an exemplary embodiment of the present invention;

FIG. 2A is a schematic plan view of a diffusion sheet according to an exemplary embodiment of the present invention;

FIG. 2B is a cross-sectional view of the diffusion sheet taken along line I-I of FIG. 2A;

FIG. 3A is an exploded top perspective view of a first mold frame and a first fastening member according to an exemplary embodiment of the present invention;

FIG. 3B is a bottom perspective view of the first mold frame coupled with the first fastening member of FIG. 3A;

FIG. 3C is an enlarged view of portion A of FIG. 3B;

FIG. 3D is a cross-sectional view of the first mold frame taken along line II-II of FIG. 3B;

FIG. 4A is an exploded top perspective view of the diffusion sheet of FIG. 2A and the first mold frame with which the first fastening member is coupled as illustrated in FIG. 3B;

FIG. 4B is a plan view showing an arrangement of the first fastening member of FIG. 3A and a fastening hole of the diffusion sheet of FIG. 2A;

FIGS. 5A and 5B are enlarged views of portion B of FIG. 4B showing a process of coupling the first fastening member in FIG. 3A with the diffusion sheet of FIG. 2A;

FIG. 6 is a perspective view illustrating an alternative exemplary embodiment of the first fastening member of FIG. 3A;

FIG. 7 is an exploded top perspective view of a backlight unit according to another exemplary embodiment of the present invention;

FIG. 8 is an enlarged perspective view of portion C of FIG. 7 of a second fastening member of the backlight unit of FIG. 7;

FIG. 9A is a plan view showing an arrangement of a coupling hole of a chassis and a fastening hole of a diffusion sheet according to an exemplary embodiment of the present invention;

FIG. 9B is a plan view showing that the second fastening member of FIG. 8 is coupled with the coupling hole of the chassis and the fastening hole of the diffusion sheet of FIG. 9A;

FIG. 9C is a plan view illustrating a modification of the coupling hole of FIG. 9A;

FIGS. 10A and 10B are perspective views showing a third fastening member and a fourth fastening member which are alternative exemplary embodiments of the second fastening member of FIG. 8; and

FIG. 11 is an exploded top perspective view of a liquid crystal display device including a backlight unit according to an exemplary embodiment of the present invention.

### DETAILED DESCRIPTION OF THE INVENTION

The invention now will be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, exemplary embodiments of the present invention will be described in further detail with reference to the accompanying drawings.

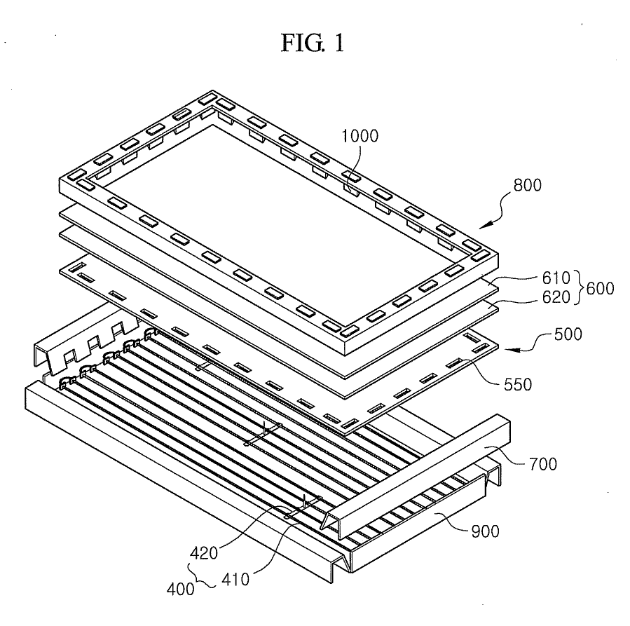

FIG. 1 is an exploded top perspective view of a backlight unit according to an exemplary embodiment of the present invention.

Referring to FIG. 1, the backlight unit includes a light source unit 400, a diffusion sheet 500, optical sheets 600, a first mold frame 800, second mold frames 700, a bottom chassis 900 and fastening members 1000.

The second mold frames 700, e.g., side mold frames, are coupled to left and right sidewalls of the bottom chassis 900. The bottom chassis 900 with which the second mold frames 700 are coupled is formed in the approximate shape of a hexahedral box with an open upper side, so that a receiving space having a predetermined depth is defined therein.

The light source unit 400 includes a plurality of U-shaped lamps 410 disposed in a direction substantially parallel to each other and a plurality of lamp fixing members 420 for supporting the lamps. The light source unit 400 is disposed in the receiving space of the bottom chassis 900. In the present exemplary embodiment, the lamps 410 may be cold cathode fluorescent lamps, each of which includes a glass tube which contains an inert gas with cathode and anode electrodes installed at both ends. However, alternative exemplary embodiments are not limited to U-shaped lamps. Lamps which are bar-shaped may be used, for example, but are not limited thereto. In addition, although the lamp is used as a light source of the light source unit 400 in exemplary embodiments described herein, alternative exemplary embodiments are not limited thereto. For example, another light source such as a light emitting diode or other appropriate light source may be used.

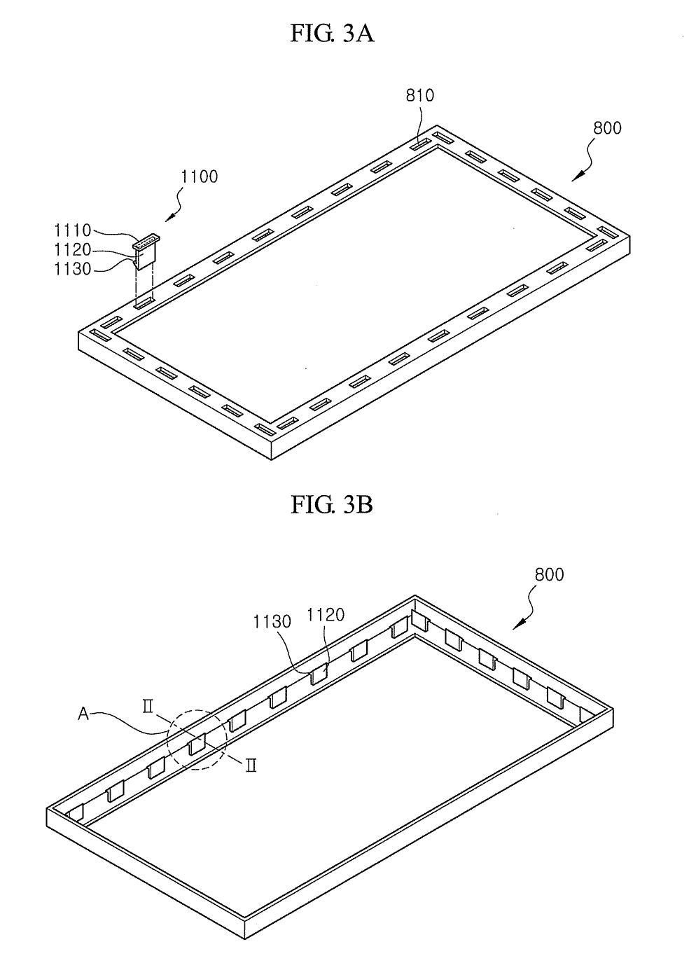

The first mold frame 800, e.g., a middle mold frame, is formed in the approximate shape of a rectangle. Coupling holes 810 (FIG. 3A) are formed in a marginal region of the first mold frame 800 and the fastening members 1000 are coupled to the respective coupling holes 810. A liquid crystal display (“LCD”) panel (not shown) is received in and supported by an upper face of the first mold frame 800, e.g., on a side of the first mold frame 800 opposite the bottom chassis 900. Although the structure in which the fastening members 1000 are coupled to is the first mold frame 800 in exemplary embodiments described herein, the present invention is not limited thereto. For example, but not limited thereto, the fastening members 1000 can be coupled to the bottom chassis 900 or the second mold frames 700.

The diffusion sheet 500 is formed with fastening holes 550 such that the number and size of the fastening holes 550 correspond to those of the fastening members 1000 coupled to the first mold frame 800. The diffusion sheet 500 is securely disposed on a rear face of the first mold frame 800 by coupling the fastening members 1000 to the fastening holes 550. The optical sheets 600 include a prism sheet 610 and a protection sheet 620 which are sequentially disposed on an upper surface of the diffusion sheet 500 fixed to the first mold frame 800.

The diffusion sheet 500 causes the light supplied by the plurality of lamps 410 to be directed toward a front surface of the LCD panel (not shown) and diffuses the light which provides a uniform distribution of the light over a wide area to the LCD panel. The prism sheet 610 disposed over the diffusion sheet 500 redirects the incident light such that the light exits in a direction substantially perpendicular to the prisms sheets 610. Although only one prism sheet 610 is used in exemplary embodiments described herein, two or more prism sheets can be employed in alternative exemplary embodiments. Furthermore, a functional optical sheet (not shown) with various functions can also be disposed in alternative exemplary embodiments of the present invention.

As described above, the optical sheets 600 are disposed over the diffusion sheet 500 after the diffusion sheet 500 is coupled and fixed to the fastening members 1000, eliminating a need to use a diffusion plate (not shown) which supports the diffusion sheets. Therefore, the benefits of reduced manufacturing costs for a diffusion plate and reduced defects generated in a diffusion plate flow from exemplary embodiments of the present invention.

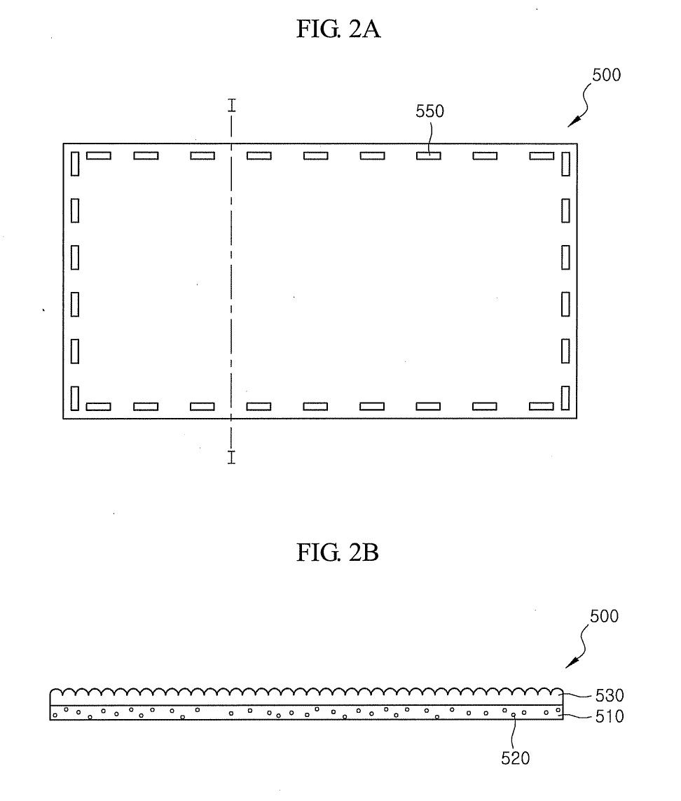

FIG. 2A is a schematic plan view of a diffusion sheet according to an exemplary embodiment of the present invention, and FIG. 2B is a cross-sectional view of the diffusion sheet taken along line I-I of FIG. 2A.

Referring to FIGS. 2A and 2B, the fastening holes 550, to which the fastening members are coupled, are formed in a marginal region of the diffusion sheet 500. The fastening holes 550 are formed such that a number and size of the fastening holes 550 corresponds to a same number and size of the fastening members 1000. In exemplary embodiments described herein, each of the fastening holes 550 is formed in a rectangular shape. However, in alternative exemplary embodiments, a shape of each fastening hole may be modified to correspond with a shape of a fastening member having a shape which is not rectangular.

Further, referring to FIG. 2B, the diffusion sheet 500 includes a base film 510, a plurality of diffusion beads 520 and a diffusion pattern 530, which increases diffusion capabilities of the diffusion sheet 500. More specifically, the plurality of diffusion beads 520 are distributed in the base film 510, as illustrated in FIG. 2B. The base film 510 may be made from polyethylene terephthalate (“PET”), for example, but is not limited thereto. The diffusion pattern 530 is concavo-convexly formed on the base film 510 and is made of acrylic resin. However, the shape and material of the diffusion pattern 530 are not limited thereto. Light incident to the diffusion sheet 500 is primarily diffused by the diffusion beads 520 and secondarily diffused by the diffusion pattern 530. Thus, the diffusion capability is increased, thus improving the luminance uniformity of the light.

FIG. 3A is an exploded top perspective view of a first mold frame and a first fastening member according to an exemplary embodiment of the present invention, FIG. 3B is a bottom perspective view of the first mold frame coupled with the first fastening member of FIG. 3A, FIG. 3C is an enlarged view of portion A of FIG. 3B, and FIG. 3D is a cross-sectional view of the first mold frame taken along line II-II of FIG. 3B.

FIG. 3A illustrates a state where a first fastening member 1100, which is one exemplary embodiment of the fastening members 1000 illustrated in FIG. 1, has not yet been coupled to the first mold frame 800. FIGS. 3B to 3D illustrate a state where the first fastening members 1100 has been coupled to the first mold frame 800.

Referring to FIGS. 3A to 3D, the first fastening member 1100 includes a fixing section 1110, a first body 1120 and a first head 1130.

The first head 1130 is formed at one end of the first body 1120, and the fixing section 1110 is formed at the other end of the first body 1120. The first body 1120 is formed in an approximately rectangular shape, and the fixing section 1110 is formed to intersect an extending portion of the first body 1120. The fixing section 1110 is formed having a larger size than that of the coupling hole 810 formed in the first mold frame 800. The first head 1130 is formed on an end of the first body 1120 opposite the fixing section 1110 and is formed having a taper such that a thickness thereof is gradually reduced from one end of the first head 1130 to another end of the first head 1130, as illustrated in FIG. 3D.

To couple the first fastening member 1100 to the coupling hole 810 of the first mold frame 800, the first head 1130 and the first body 1120 completely pass through the coupling hole 810 and are fixed by the fixing section 1110. A recess (not shown) corresponding in size to the fixing section 1110 may be formed in an upper surface of the first mold frame 800 on which the fixing section 1110 is disposed, thereby increasing fastening force. In alternative exemplary embodiments, the size and shape of the first body 1120, the first head 1130 and the fixing section 1110 can be modified without deviating from the spirit and scope of exemplary embodiments of the present invention.

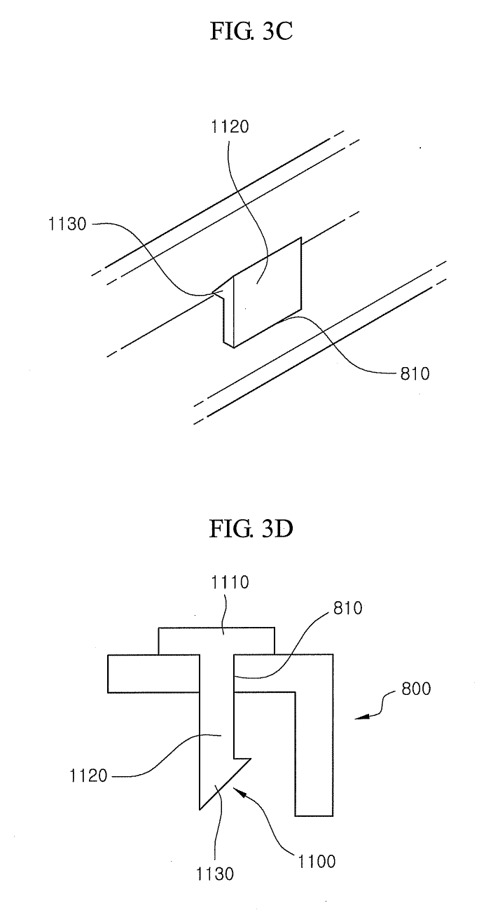

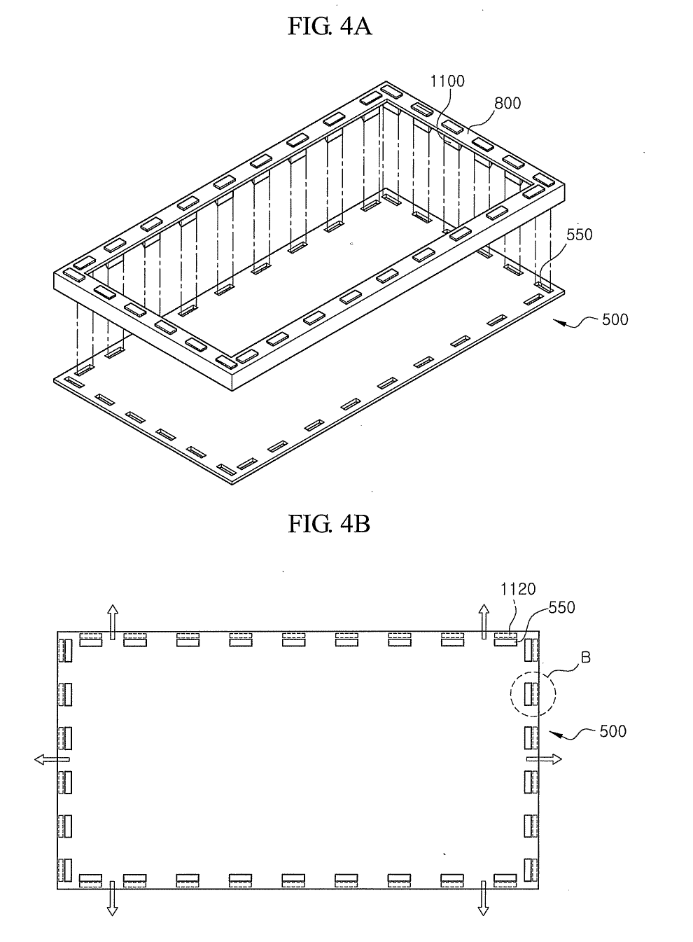

FIG. 4A is an exploded top perspective view of the diffusion sheet of FIG. 2A and the first mold frame with which the first fastening member is coupled as illustrated in FIG. 3B, FIG. 4B is a plan view which shows an arrangement of the first fastening member in FIG. 3A and a fastening hole of the diffusion sheet in FIG. 2A, and FIGS. 5A and 5B are enlarged views of portion B of FIG. 4B showing a process of coupling the first fastening member in FIG. 3A with the diffusion sheet in FIG. 2A.

Referring to FIGS. 4A to 5B, the diffusion sheet 500 is fixedly supported by a plurality of the first fastening members 1100 coupled to the first mold frame 800.

The size of the diffusion sheet 500 varies with changing surrounding environmental conditions (e.g., different temperature and/or moisture combinations cause the diffusion sheet 500 to expand and/or contract). If the diffusion sheet 500 is not coupled tightly to the first fastening member 1100, the diffusion sheet 500 shrivels or sags, causing the luminance distribution of light to become non-uniform. In order to prevent this, the first fastening member 1100 is made of a material having elasticity, and the central axis of the first fastening member 1100, e.g., the central axis of the first body 1120, and the center of the fastening hole 550 of the diffusion sheet 500 are eccentrically disposed with respect to each other. More specifically, the first fastening member 1100 and the fastening hole 550 are disposed such that the first body 1120 is positioned outside the fastening hole 550 when the first fastening member 1100 is not coupled to the fastening hole 550, as illustrated in FIG. 5A. Since the central axis of the first fastening member 1100 does not coincide with that of the fastening hole 550 when the first head 1130 of the first fastening member 1100 is inserted into the fastening hole 550 of the diffusion sheet 500, the first body 1120 is partially elastically deformed and then coupled to the fastening hole. After the first head 1130 of the first body 1120 passes through the fastening hole 550, a restoration force which tends to restore the first body 1120 to its original shape is generated in the first body 1120 due to its elasticity, as illustrated in FIG. 5B. Due to the restoration force of the first body 1120, a tension force is continuously applied to the diffusion sheet 500, as illustrated in FIG. 4B. As a result, the diffusion sheet 500 is tightly coupled to the first fastening members 1100, so that the diffusion sheet is supported without a diffusion plate, effectively preventing the diffusion sheet from shriveling or sagging when the surrounding environmental conditions change.

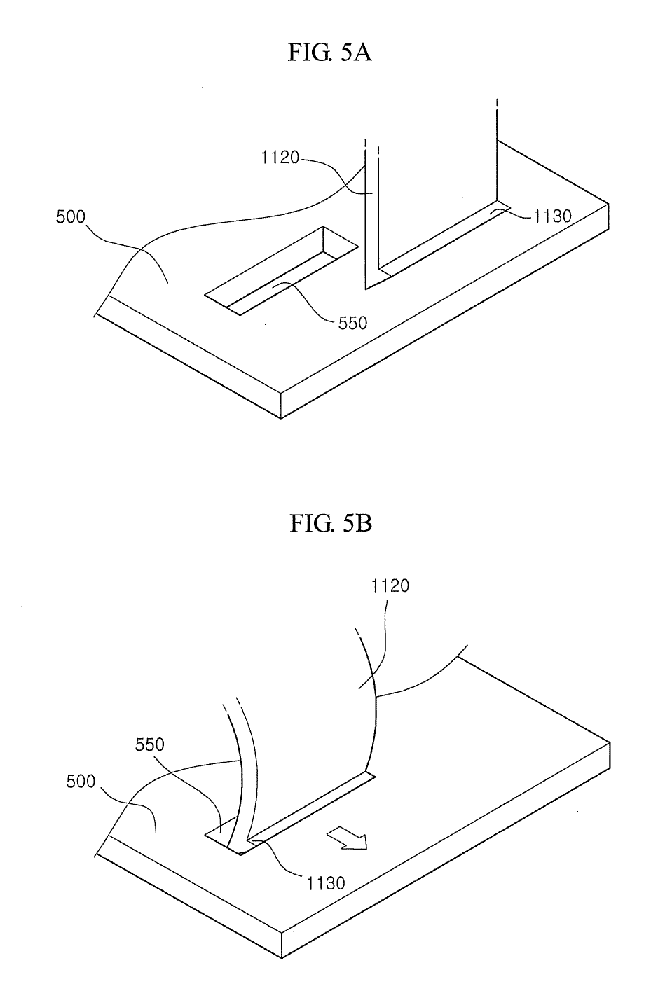

FIG. 6 is a perspective view illustrating a modification of the first fastening member in FIG. 3A according to an alternate exemplary embodiment of the present invention.

Referring to FIG. 6, a first fastening member 1100 includes a fixing section (not shown), a first body 1120 and a first head 1135. As shown in FIG. 6, the first head 1135 is formed not to extend in the same direction as the extending direction of the first body 1120 but to be inclined at a predetermined angle with respect to the first body 1120. When the first head 1135 is formed to be inclined at a predetermined angle with respect to the first body 1120, the first head 1135 slides into and is inserted into the fastening hole 550 in the diffusion sheet 500, as described above, so that coupling is more easily accomplished.

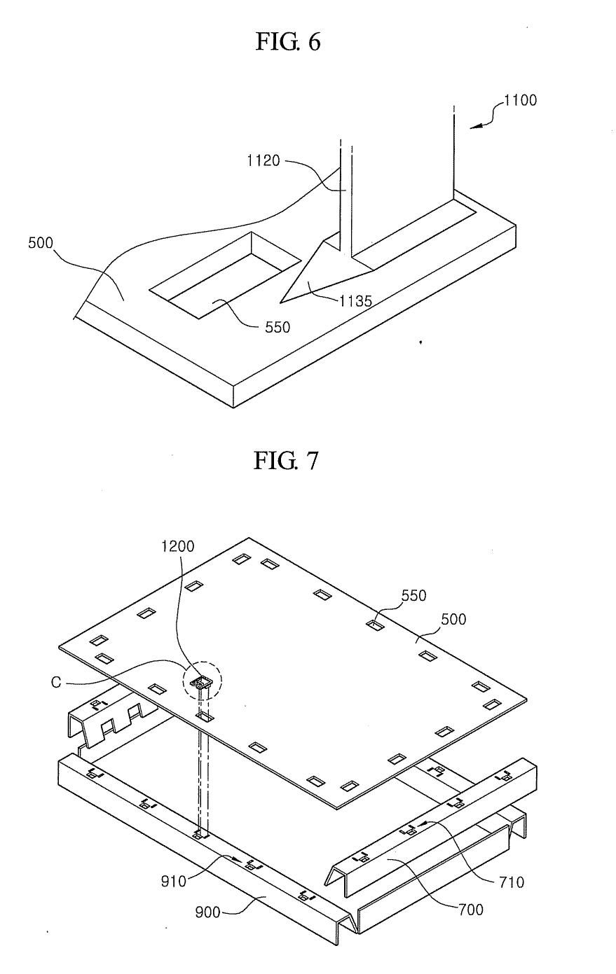

FIG. 7 is an exploded top perspective view of a backlight unit according to another exemplary embodiment of the present invention.

Referring to FIG. 7, the backlight unit includes a lamp unit (not shown), a diffusion sheet 500, optical sheets (not shown), a first mold frame (not shown), second mold frames 700, a bottom chassis 900 and second fastening members 1200, which differ from the first fastening members 1100 described above according another exemplary embodiment.

The second mold frames 700, e.g., side mold frames, are coupled to the left and right sidewalls of the bottom chassis 900. The bottom chassis 900 with which the second mold frames 700 are coupled is formed in the shape of a hexahedral box with an open upper side, so that a receiving space having a predetermined depth is defined therein.

Coupling holes 710 and 910 are formed in marginal areas of the second mold frames 700 and the bottom chassis 900, and the second fastening members 1200 are coupled to the coupling holes 710 and 910, respectively.

The diffusion sheet 500 is formed with fastening holes 550 corresponding to the second fastening members 1200. The second fastening members 1200 are coupled to the fastening holes 550, so that the diffusion sheet 500 is securely disposed on the bottom chassis 900. Then, the optical sheets (not shown) are sequentially disposed on the diffusion sheet 500 fixed to the second fastening members 1200.

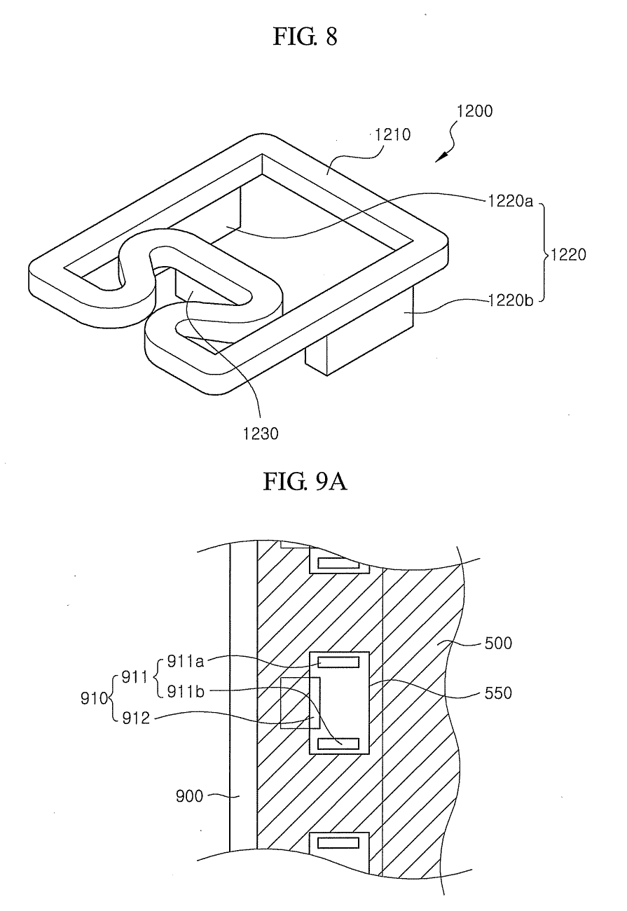

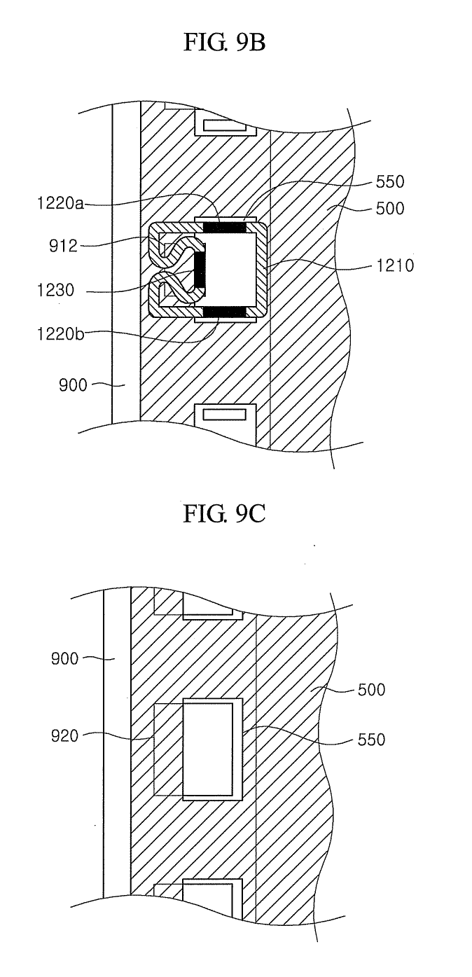

FIG. 8 is an enlarged perspective view of portion C of FIG. 7 of a second fastening member of the backlight unit of FIG. 7, FIG. 9A is a plan view showing an arrangement of a coupling hole of a chassis and a fastening hole of a diffusion sheet according to an exemplary embodiment of the present invention, FIG. 9B is a plan view showing the second fastening member of FIG. 8 coupled with the coupling hole of the chassis and the fastening hole of the diffusion sheet of FIG. 9A, and FIG. 9C is a plan view illustrating a modification of the coupling hole of FIG. 9A according to alternative exemplary embodiments of the present invention.

Referring to FIG. 8, the second fastening member 1200 includes a base section 1210, a protrusion section 1220 and a second body 1230. The base section 1210 is provided with an elastic structure, and the protrusion section 1220 is formed on the base section 1210. The protrusion section is coupled to the coupling holes 710 and 910 of FIG. 7, whereby the second fastening member 1200 is fixed to the second mold frames 700 and the bottom chassis 900. The second body 1230 is formed on the base section 1210 and is coupled to the fastening hole 550 of the diffusion sheet 500. A second head (not shown) may be formed at an end of the second body 1230.

The base section 1210 is formed in the shape of a close-looped curve, e.g., substantially a rectangle with a portion of a side disposed inward, as illustrated in FIG. 8. A portion of the base section 1210 is also depressed toward the center of the base section and formed in a curve, thereby forming the elastic structure. The second body 1230 is formed at a first side (not shown) of the base section 1210 on which the elastic structure is formed. The protrusion section 1220 includes first and second protrusions 1220a and 1220b formed on second and third sides (not shown), respectively, which are adjacent to the first side. In alternative exemplary embodiments of the present invention, the structure of the protrusion section 1220 is not limited as described herein. For example, the protrusion section 1220 may include only one protrusion, or three or more protrusions. Also, the location on which the protrusion is formed can differ in alternative exemplary embodiments of the present invention.

Referring to FIGS. 9A and 9B, the coupling hole 910 formed in the bottom chassis 900 includes first coupling holes 911 (911a and 911b) and a second coupling hole 912. The first coupling holes 911 are formed to correspond in number, size and location to the protrusion section 1220, whereby the protrusion section 1220 is inserted into and coupled to the first coupling holes 911. In order for the second body 1230 of the second section 1200 to be disposed in the second coupling hole 912, the second coupling hole 912 is formed to be larger than the second body 1230. The central axis of the second body 1230 of the second fastening member 1200 and the center of the fastening hole 550 of the diffusion sheet 500 are eccentrically disposed with respect to each other, e.g., the second fastening member 1200 and the fastening hole 550 are disposed such that the second body 1230 is positioned outside the fastening hole 550 when the second fastening member 1200 is not coupled to the fastening hole 550. Coupling the second fastening member 1200 to the diffusion sheet 500 of this exemplary embodiment is completed in the same manner as described above in reference to previous exemplary embodiments. Like the coupling holes 910 of the bottom chassis 900, the coupling holes 710 formed in the second mold frames 700 include first and second coupling holes as illustrated in FIG. 7, and are coupled together in a similar manner as described above.

FIG. 9C shows a modification of coupling holes formed in the bottom chassis 900 and the second mold frame (not shown in FIG. 9C) according to an alternative exemplary embodiment of the present invention. Unlike the coupling holes 910 shown in FIGS. 9A and 9B, only a single coupling hole 920 is formed in the bottom chassis 900 in FIG. 9C. The first and second protrusions (not shown) of the second fastening member are coupled and fixed to two inner sides of the coupling hole 920.

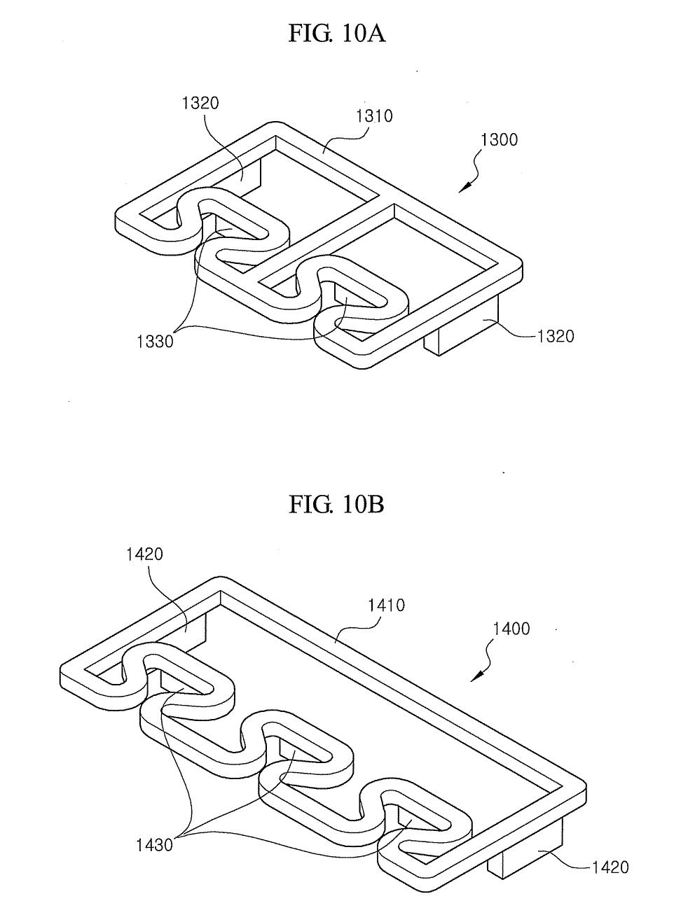

FIGS. 10A and 10B are perspective views showing a third fastening member 1300 and a fourth fastening member 1400 which are modifications of the second fastening member 1200 of FIG. 8 according to an alternative exemplary embodiments of the present invention.

Referring to FIGS. 10A and 10B, the third fastening member 1300 and the fourth fastening member 1400 are formed by integrally connecting a plurality of the second fastening members 1200 to each other to easily couple the fastening member to the bottom chassis and the second mold frame.

The third fastening member 1300 shown in FIG. 10A includes a base section 1310 formed in the shape of two close-looped curves, at each of which an elastic structure is configured, protrusion sections 1320, and two third bodies 1330 formed on the elastic structures. Alternative exemplary embodiments of present invention are not limited thereto, rather the number and shape thereof can be changed.

Likewise, the fourth fastening member 1400 shown in FIG. 10B includes a base section 1410 formed in the shape of a single close-looped curve and having three elastic structures, protrusion sections 1420, and three third bodies 1430 formed on the elastic structures.

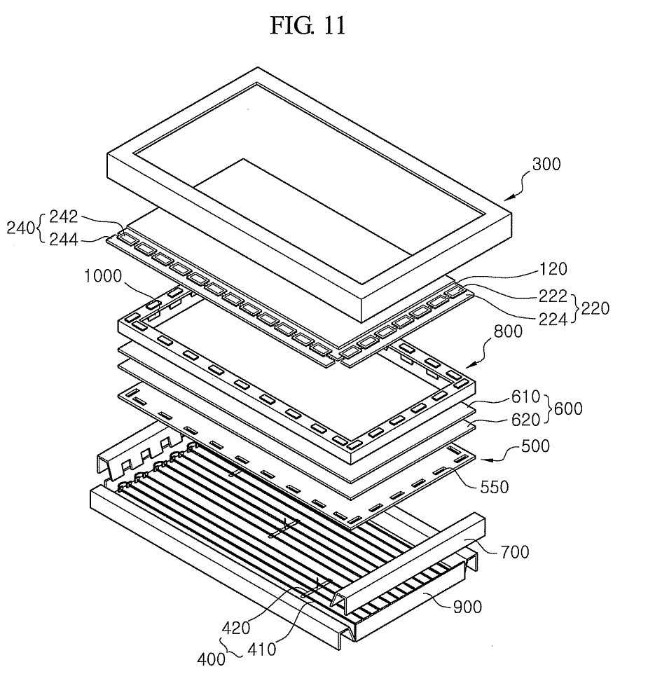

FIG. 11 is an exploded top perspective view of an LCD device provided with the backlight unit described herein according to an exemplary embodiment of the present invention.

Referring to FIG. 11, the LCD device includes a top chassis 300, an LCD panel 100, driving circuit units 220 and 240 and a backlight unit, which includes a lamp unit 400, a diffusion sheet 500, optical sheets 600, a first mold frame 800, second mold frames 700, a bottom chassis 900 and fastening members 1000. The diffusion sheet 500 is formed with fastening holes 550 such that the number and size of the fastening holes 550 correspond to those of the fastening members 1000 coupled to the first mold frame 800. The optical sheets 600 include a prism sheet 610 and a protection sheet 620. The lamp unit includes a plurality of U-shaped lamps 410 disposed in a direction substantially parallel to each other and a plurality of lamp fixing members 420 for supporting the lamps. The backlight unit was previously described in further detail in reference to other exemplary embodiments of the present invention herein.

The LCD panel 100 is disposed over the first mold frame 800. The driving circuit units 220 and 240 include a gate side printed circuit board (“PCB”) 224 connected to the LCD panel 100 and having a control integrated circuit (“IC”) (not shown) mounted thereto which supplies a gate signal to a gate line of a thin film transistor (“TFT”) substrate 120, a data side printed circuit board 244 having a control IC (not shown) mounted thereto which supplies a data signal to a data line of the TFT substrate 120, a gate side flexible printed circuit board 222 for connecting the TFT substrate 120 and the gate side printed circuit board 224, and a data side flexible printed circuit board 242 for connecting the TFT substrate 120 and the data side printed circuit board 244. The gate side and data side printed circuit boards 224 and 244, respectively, are connected to the gate side and data side flexible printed circuit boards 222 and 242, respectively, to supply a gate driving signal and an external image signal. The gate side and data side printed circuit boards 224 and 244, respectively, are integrated to form a single printed circuit board (not shown). Also, driving ICs (not shown) are mounted to the flexible printed circuit boards 222 and 242, to transmit red (R), green (G) and blue (B) signals generated from the printed circuit boards 224 and 244 and power, for example, but is not limited thereto, to the LCD panel 100.

The upper chassis 300 is coupled to the bottom chassis 900 and the second mold frame 700 in order to cover an edge portion of the LCD panel 100, e.g., a non-display region and an outer surface of the first mold frame 800.

According to exemplary embodiments of the present invention as described herein, an LCD having a structure which fixedly supports a diffusion sheet without a diffusion plate provides advantages which include, but are not limited to, saving manufacturing costs and effectively reducing or eliminating problems caused from defects of the diffusion plate.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A backlight unit, comprising:
a receiving member having a receiving space formed therein and a coupling hole formed therein;
a fastening member coupled to the coupling hole of the receiving member; and
a sheet having a fastening hole formed therein,
wherein the fastening member is coupled to the fastening hole to fix the sheet to the receiving member.

2. The backlight unit as claimed in claim 1, wherein the sheet is a diffusion sheet comprising a base film, a plurality of diffusion beads distributed in the base film, and a diffusion pattern formed on the base film.

3. The backlight unit as claimed in claim 1, wherein the receiving member comprises a first mold frame, and the coupling hole is formed in the first mold frame.

4. The backlight unit as claimed in claim 1, wherein the receiving member comprises a chassis, and the coupling hole is formed in the chassis.

5. The backlight unit as claimed in claim 1, wherein the receiving member comprises a chassis and a second mold frame coupled to a sidewall of the chassis, and the coupling hole is formed in the second mold frame.

6. The backlight unit as claimed in claim 1, wherein the fastening hole is formed in a marginal region of the sheet.

7. The backlight unit as claimed in claim 1, wherein the fastening member comprises a first fastening member, the first fastening member comprising a first body and a first head formed at an end of the first body.

8. The backlight unit as claimed in claim 7, wherein the first fastening member further comprises a fixing section formed at an opposite end of the first body, the fixing section being larger than the coupling hole.

9. The backlight unit as claimed in claim 7, wherein the first head is formed to taper such that a thickness thereof is gradually reduced from one end thereof to another end thereof.

10. The backlight unit as claimed in claim 7, wherein the first head is formed to be inclined at a predetermined angle with respect to the first body.

11. The backlight unit as claimed in claim 7, wherein a central axis of the first body of the first fastening member and a center of the fastening hole of the sheet are eccentrically disposed with respect to each other.

12. The backlight unit as claimed in claim 7, wherein the fastening hole of the sheet is coupled to the first body of the first fastening member.

13. The backlight unit as claimed in claim 1, wherein the fastening member comprises a second fastening member, the second fastening member comprises a base section having an elastic structure, a protrusion section formed on the base section and is coupled to the coupling hole of the receiving member, and a second body formed on the base section and coupled to the fastening hole of the sheet.

14. The backlight unit as claimed in claim 13, wherein the base section is formed in a shape of a close-looped curve, and a portion of the base section is depressed toward a center of the base section and formed to be curved, thereby forming an elastic structure.

15. The backlight unit as claimed in claim 13, wherein the second fastening member is formed by integrally connecting a plurality of the second fastening members.

16. The backlight unit as claimed in claim 13, wherein a central axis of the second body of the second fastening member and a center of the fastening hole of the sheet are eccentrically disposed with respect to each other.

17. The backlight unit as claimed in claim 14, wherein the second fastening member further comprises a second head formed at an end of the second body.

18. The backlight unit as claimed in claim 14, wherein the coupling hole is formed to correspond in size to the base section of the second fastening member.

19. The backlight unit as claimed in claim 14, wherein the coupling hole comprises a first coupling hole formed to correspond in size and location to the protrusion section of the second fastening member, and a second coupling hole formed to be larger than the second body of the second fastening member.

20. A liquid crystal display device, comprising:
a receiving member having a receiving space formed therein and a coupling hole formed therein;
a fastening member coupled to the coupling hole of the receiving member; a backlight unit comprising a diffusion sheet having a fastening hole formed therein, a light source unit disposed in the receiving member and an optical sheet disposed over the diffusion sheet, wherein the fastening member is coupled to the fastening hole to fix the diffusion sheet to the receiving member; and
a liquid crystal display panel disposed over the backlight unit.
